(19) United States
(12) Patent Application Publication
(10) Pub. No.: US 2026/0233036 A1
(43) Pub. Date: Aug. 13, 2026

(54) STRAIGHT LOOP INSERT

(71) Applicant: WERNER CO., Itasca, IL (US)

(72) Inventors: Glenn Hartop, Austin, TX (US); Ivan A.J. Kekahuna, Austin, TX (US); Cody Matthew Rappoport, Greenville, PA (US)

(21) Appl. No.: 19/532,311

(22) Filed: Feb. 6, 2026

Related U.S. Application Data
(60) Provisional application No. 63/755,347, filed on Feb. 7, 2025.

(51) Int. Cl. A62B 35/00

(52) U.S. Cl. CPC A62B 35/0068

(57) ABSTRACT

A straight loop insert attaches to a support surface defining a first side, a second side opposite the first side, and an aperture extending through the first and second sides. The straight loop insert includes a support member having a main body with a threaded bore, a seal coupled to the support member, a snap-fit member having a body and a plurality of deflectable projections extending radially outwardly from the body, and a fastener having a head and a shaft configured to extend through the seal and the snap-fit member and coupled with the threaded bore to retain the straight loop insert in an assembled configuration. When the straight loop insert is coupled to the support surface, the seal is configured to press against the first side of the support surface and distal ends of the projections are configured to abut the second side of the support surface.

### CROSS-REFERENCE TO RELATED APPLICATIONS

The present application claims priority to U.S. Provisional Patent Application No. /755,347, filed February 7, 2025, the entire contents of which are incorporated herein by reference.

### FIELD OF THE DISCLOSURE

The present disclosure relates to fall protection systems, and more particularly, to a cast in place insert.

### BACKGROUND

Fall protection systems typically require anchor points attached to a structure. A user may then attach a lanyard to the anchor point. One type of anchor point is formed by casting an insert in place in newly poured concrete. The insert acts as a receptacle to which a ring or other type of connection mechanism may be attached to create the anchor point. There are challenges to securing the insert in place while the concrete is being poured. In an existing insert, a mounting plug is nailed into a wood decking that the concrete will be poured onto, and the insert is screwed onto the mounting plug. After the concrete is poured, the mounting plug may be removed and a ring or other type of connection mechanism may be attached to the cast in place insert. In another existing insert, the insert is threaded onto a bolt that extends through the decking that the concrete is poured onto to hold the insert in place while the concrete is poured. However, there remains room for improvement in cast in place inserts.

### SUMMARY

The present disclosure provides, in one aspect, a straight loop insert configured to attach to a support surface defining a first side, a second side opposite the first side, and an aperture extending through the first and second sides, including a support member including a main body having a threaded bore, a seal coupled to the support member, a snap-fit member including a body and a plurality of deflectable projections extending radially outwardly from the body, and a fastener including a head and a shaft configured to extend through the seal and the snap-fit member and coupled with the threaded bore to retain the straight loop insert in an assembled configuration, wherein when the straight loop insert is coupled to the support surface, the seal is configured to press against the first side of the support surface and distal ends of the projections are configured to abut the second side of the support surface.

The present disclosure provides, in another aspect, a straight loop insert configured to attach to a support surface defining a first side, a second side opposite the first side, and an aperture extending through the first and second sides, including a support member including a bore, a fastener removably coupled to the bore of the support member, and a snap-fit member including a body supported by the fastener and a plurality of projections extending radially outwardly from the body, wherein in response to an external force, each of the plurality of projections is movable from a first position, in which each of the plurality of projections is spaced apart from the main body by a first distance, to a second position, in which each of the plurality of projections is spaced apart from the main body by a second distance that is less than the first distance.

The present disclosure provides, in another aspect, a method of attaching a straight loop insert to a support surface defining a first side, a second side, and an aperture extending through the first and second sides, the straight loop insert including a support member having a threaded bore, a seal, a snap-fit member having a plurality of projections, and a fastener having a head and a threaded shaft, including inserting the threaded shaft of the fastener through the snap-fit member, the seal, and the aperture in the support surface, threading the fastener into the threaded bore of the support member, and pressing the head of the fastener and the snap-fit member through the aperture from the first side of the support surface to the second side of the support surface, thereby causing the plurality of projections to deflect radially inward while passing through the aperture before being biased radially outward upon exiting the aperture.

Other aspects of the disclosure will become apparent by consideration of the detailed description and accompanying drawings.

### BRIEF DESCRIPTION OF THE DRAWINGS

FIG. 1 is an exploded view of a straight loop insert in accordance with an example embodiment of the disclosed concept.

FIG. 2 is a view of the assembled straight loop insert of FIG. 1.

FIG. 3 is a view of an internally threaded member of the straight loop insert of FIG. 1.

FIG. 4 is a view of the bolt of the straight loop insert of FIG. 1.

FIG. 5 is a view of a flexible seal of the straight loop insert of FIG. 1.

FIG. 6 is another view of the flexible seal of the straight loop insert of FIG. 1.

FIG. 7 is a view of the snap-fit member of FIG. 1.

FIG. 8 is another view of the snap-fit member of the straight loop insert of FIG. 1.

FIG. 9 is a view of a straight loop insert attached to a support surface in accordance with an example embodiment of the disclosed concept.

FIG. 10 is another view of a straight loop insert attached to the support surface in accordance with an example embodiment of the disclosed concept.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and being practiced or being carried out in various ways. Also, it is to be understood that the phraseology and terminology used herein is for purpose of description and should not be regarded as limiting.

Directional phrases used herein, such as, for example, left, right, front, back, top, bottom and derivatives thereof, relate to the orientation of the elements shown in the drawings and are not limiting upon the claims unless expressly recited therein. As employed herein, the statement that two or more parts are "coupled" together shall mean that the parts are joined together either directly or joined through one or more intermediate parts.

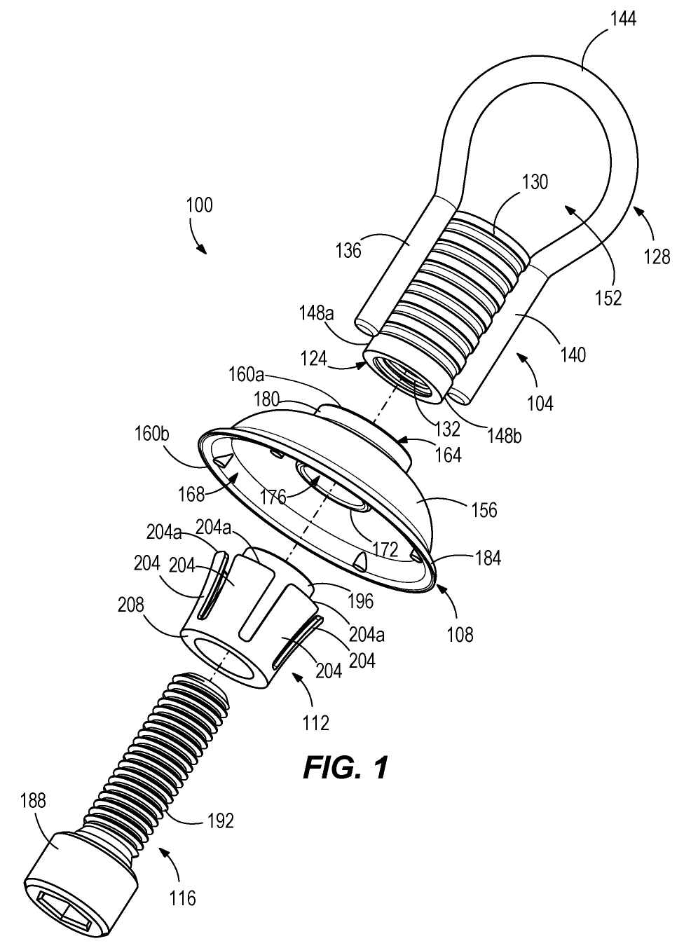

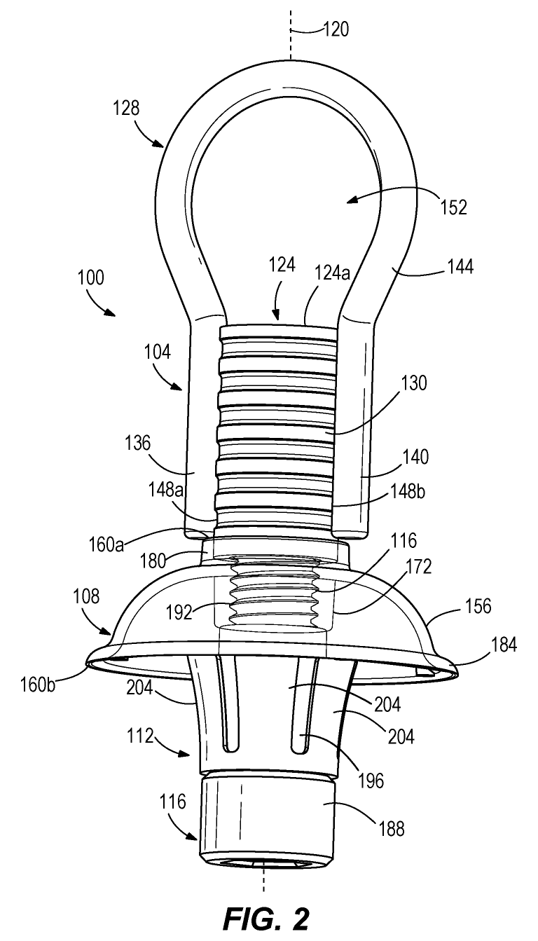

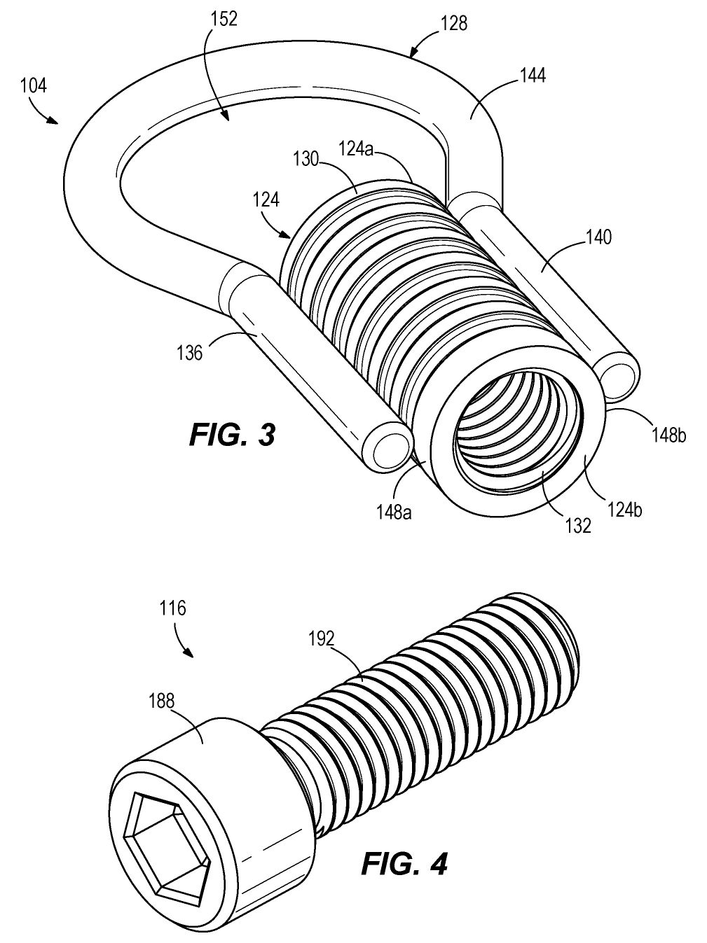

FIGS. 1-10 illustrate a straight loop insert 100 configured for use in a fall protection system and adapted to be cast in place within concrete to form an anchor point. The straight loop insert 100 includes a support member 104, a flexible seal 108 removably coupled to the support member 104, a snap-fit member 112 removably coupled to the flexible seal 108, and a fastener 116 configured to secure the support member 104, the flexible seal 108, and the snap-fit member 112 together. The straight loop insert 100 defines a longitudinal axis 120 (FIG. 2) extending through the support member 104, the flexible seal 108, the snap-fit member 112, and the fastener 116.

With reference to FIGS. 1-3, the support member 104 includes a main body 124 defining a first end 124a and a second end 124b opposite the first end 124a, and a loop member 128 attached to the main body 124. The main body 124 is generally cylindrical and includes a threaded outer surface 130 and a threaded bore 132. The first end 124aof the main body 124 is generally closed, or sealed, while the second end 124b of the main body 124 is open to the bore 132.

The loop member 128 is generally cylindrical and includes a first straight portion 136, a second straight portion 140, and a curved portion 144 extending between the first straight portion 136 and the second straight portion 140. The first straight portion 136 is coupled to a first side 148a of the main body 124, and the second straight portion 140 is coupled to a second side 148b of the main body 124 opposite the first side 148a. The curved portion 144 cooperates with the end 124b of the main body 124 to define an aperture 152. The aperture 152 may receive a structural member, such as a reinforcing bar, to secure the support member 104 when cast in place. The loop member 128 therefore provides an attachment feature for engagement with a structural member during installation.

In the illustrated embodiments, the loop member 128 is coupled to the sides 148a, 148b of the main body 124. In some embodiments, the loop member 128 may be integrally formed with the main body 124. Further, in some embodiments, the loop member 128 may include threads corresponding to the threaded outer surface 130. Additionally, the main body 124 may include grooves configured to further assist with securing the support member 104 within concrete. During use, the support member 104 is cast in concrete and the loop member 128 serves as part of an anchor point in the fall protection system.

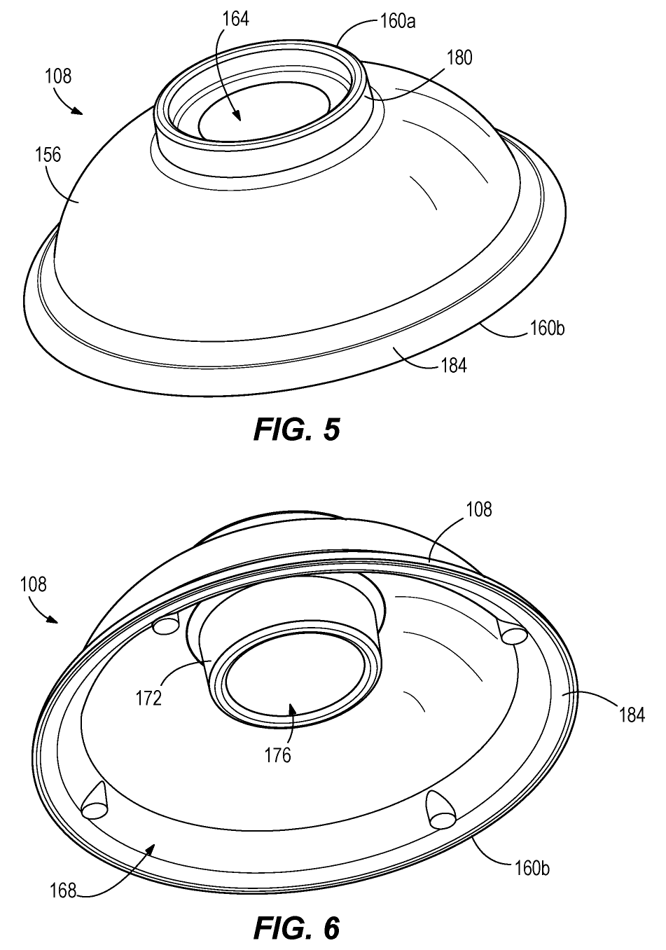

With reference to FIGS. 5-6, the flexible seal 108 has a generally truncated, semispherical shape defined by a flexible, curved wall 156 extending between a first end 160a and an opposite second end 160b. The curved wall 156 includes a first opening 164 adjacent the first end 160a, and a second opening 168 adjacent the second end 160b. Each opening 164, 168 is generally cylindrical, with the first opening 164 having a diameter generally smaller than a diameter of the second opening 168. The curved wall 156 tapers radially outward along the longitudinal axis 120 from the first end 160a toward the second end 160b.

With continued reference to FIGS. 5-6, the seal 108 includes an internal circular wall 172 extending concentrically around the longitudinal axis 120. The circular wall 172 defines an internal passage 176 extending between the first opening 164 and the second opening 168. A first, outwardly extending flange 180, or lip, is formed adjacent the first end 160a, and a second, outwardly extending flange 184, or lip, is formed adjacent the second end 160b. The first and second flanges 180, 184 extend radially outward from the curved outer wall 156. The second flange 184 includes a diameter greater than a diameter of the first flange 180.

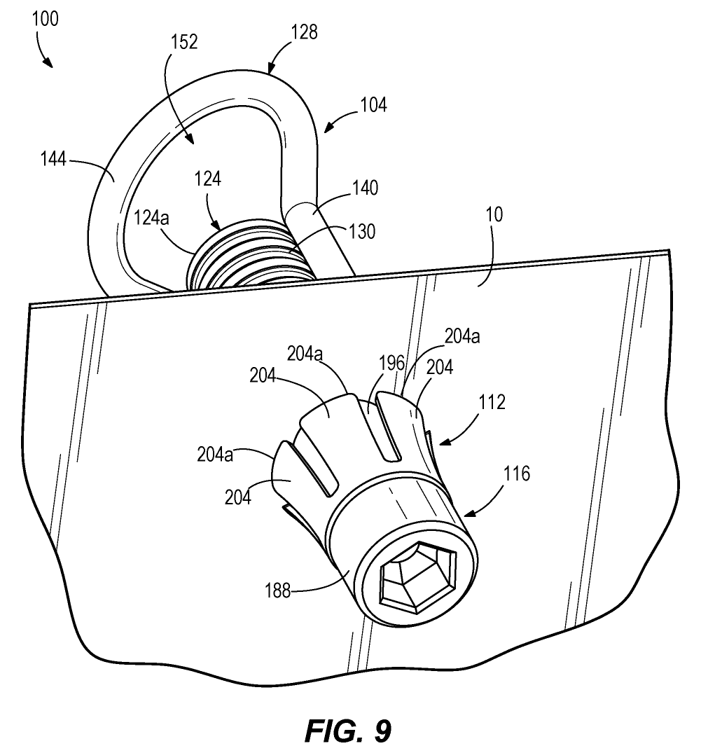

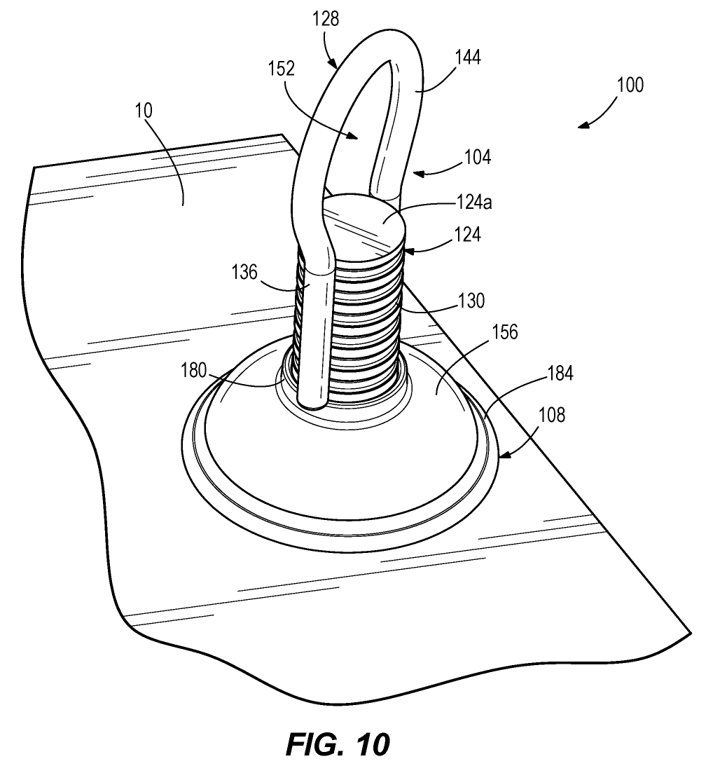

In the illustrated embodiments, the flexible seal is formed of an elastomeric material, such as rubber (e.g., thermoplastic polyurethate (TPU)), or another flexible material. As shown in FIGS. 2 and 5, the first opening 164 is shaped and sized to removably engage the threaded outer surface 130 of the main body 124 of the support member 104. The second opening 168 is shaped and sized to seal against a support surface 10 (e.g., decking) to which the straight loop insert 100 is attached (FIGS. 9 and 10). The flexible seal 108 prevents concrete from entering or otherwise blocking the bore 132 of the support member 104. After the support member 104 is cast in concrete, the flexible seal 108 may either remain embedded in the concrete or may be removed, depending on the intended application.

With reference to FIG. 4, the fastener 116 is a generally conventional machine bolt including a head 188 and a threaded shaft 192. The fastener 116 threads into the bore 132 of the support member 104 and may be removed after casting so that a ring, or other connection component, may be attached instead. The fastener 116 may be composed of any suitable material such as, without limitation, a metallic or plastic material. Although the fastener 116 shown in FIGS. 1-10 is a bolt, other threaded fasteners, such as screws, studs, etc., may be implemented.

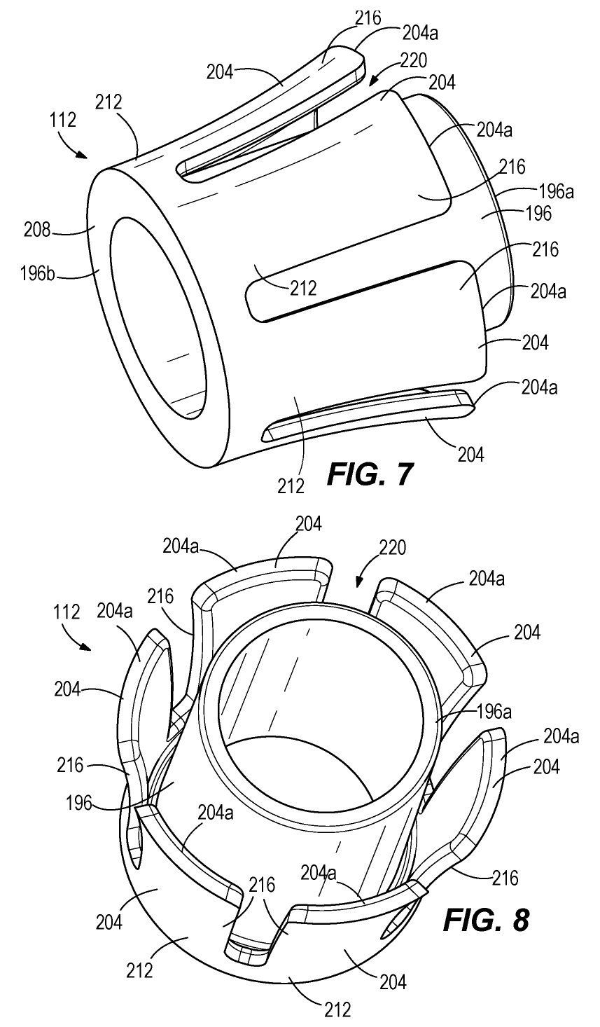

With reference to FIGS. 7-8, the snap-fit member 112 includes a hollow, cylindrical body 196 defining a central aperture 200 and projections 204, or flares, extending from the body 196. A connecting wall portion 208 extends between the body 196 and the projections 204. The body 196 includes a first end 196a, and a second end 196b opposite the first end 196a, and the connecting wall portion 208 extends from the second end 196b substantially perpendicular to a plane defined by the cylindrical body 196.

The projections 204 extend outwardly from the body 196 and are arranged circumferentially around the longitudinal axis 120. With continued reference to FIGS. 7-8, each projection 204 includes a base portion 212 coupled to the connecting wall portion 208, and an outwardly diverging portion 216, such that distal ends 204a of the projections 204 collectively define an opening 220 having a diameter greater than a diameter of the cylindrical body 196. That is, the diverging portions 216 are spaced apart from the body 196 at a distance greater than the base portions 212. The projections 204 are formed of a resilient, flexible material and are configured to flex, or deflect, radially inward toward the longitudinal axis 120 from a first, relaxed position, to a second, compressed position when subjected to a force. In the illustrated embodiments, the snap-fit member 112 includes six projections 204. However, in alternative embodiments, the snap-fit member 112 may include fewer or additional projections 204.

The cylindrical body 196 has an internal diameter that is larger than a diameter of the threaded shaft 192 of the fastener 116, but smaller than a diameter of the head 188 of the fastener 116. Therefore, as shown in FIG. 2, when the straight loop insert 100 is assembled, the fastener 116 extends into and through the cylindrical body 196 such that the snap-fit member 112 is positioned around the threaded shaft 192 and seated between the head 188 and the flexible seal 108. More specifically, the threaded shaft passes through the central aperture 200 of the snap-fit member 112, the internal passage 176 of the seal 108, and the threaded bore 132 of the support member 104, thereby securing the straight loop insert 100 into an assembled configuration.

With reference to FIGS. 9 and 10, the straight loop insert 100 is secured to the support surface 10 by inserting the head 188 of the fastener 116 and the second end 196b of the snap-fit member 112 through an aperture in the support surface 10. The aperture has a diameter larger than the diameter of the head 188 of the fastener 116, but smaller than the diameter of the opening 220 defined by the distal ends 204a of the projections 204. In some embodiments, the diameter of the aperture may be approximately 1 inch. As the fastener head 188 and snap-fit member 112 are pressed through the aperture, the projections 204 compress, or deflect, inwardly from the first position to the second position. Once the distal ends 204a of the projections 204 pass through the aperture, the projections 204 bias to the first position. In the first position, the projections 204 extend beyond a diameter of the aperture and the distal ends 204a engage an underside of the support surface 10, preventing withdrawal and other movement. That is, when the projections 204 are in the first position, the distal ends 204a collectively define an opening having a first diameter, and when the projections 204 are in the second position, they collectively define a second diameter less than the first diameter. When in the first position, the flexible seal 108 simultaneously presses against an upper surface of the support surface 10 to form a seal, which may create a suction effect that further stabilizes the straight loop insert 100.

Once the straight loop insert 100 is installed, concrete may be poured over the support surface 10 to cast the straight loop insert 100 in place. The flexible seal 108, the fastener 116, and snap-fit member 112 maintain the position of the support member 104 during the pour. After the concrete cures, the fastener 116 and the snap-fit member 112 may be removed, and a ring or other connector may be attached to the support member 104 in place of the fastener 116 to form an anchor point.

The straight loop insert 100 may be used with a wide range of support surfaces, including wood, metal (e.g., B-Deck), or other materials. The straight loop insert 100 may likewise be installed without tools and in scenarios where only one side of the support surface 10is accessible. The straight loop insert 100 may also be used on other wall-like or planar surfaces.

Various features of the disclosure are set forth in the following claims.

What is claimed is:

1. A straight loop insert configured to attach to a support surface defining a first side, a second side opposite the first side, and an aperture extending through the first and second sides, the straight loop insert comprising:
a support member including a main body having a threaded bore;
a seal coupled to the support member;
a snap-fit member including a body and a plurality of deflectable projections extending radially outwardly from the body; and
a fastener including a head and a shaft configured to extend through the seal and the snap-fit member and coupled with the threaded bore to retain the straight loop insert in an assembled configuration,
wherein when the straight loop insert is coupled to the support surface, the seal is configured to press against the first side of the support surface and distal ends of the projections are configured to abut the second side of the support surface.

2. The straight loop insert of claim 1, wherein in a first position, the distal ends of the plurality of projections collectively define an opening having a first diameter, and in a second position, the plurality of projections are deflectable inwardly to a collectively define a second diameter that is less than the first diameter.

3. The straight loop insert of claim 2, wherein the plurality of projections are biased into the first position.

4. The straight loop insert of claim 1, wherein the seal includes a first opening adjacent a first end, and a second opening adjacent a second end, wherein the second opening includes a diameter greater than a diameter of the first opening.

5. The straight loop insert of claim 4, wherein the first opening and the second opening define a passage extending through the seal, wherein the fastener is configured to extend through the passage.

6. The straight loop insert of claim 5, wherein the seal includes a curved outer wall, and a circular wall extending within the curved wall, wherein the passage extends through the circular wall.

7. The straight loop insert of claim 4, wherein the seal includes a first flange formed adjacent the first end, and a second flange formed adjacent the second end, wherein the second flange includes a diameter greater than a diameter of the first flange.

8. The straight loop insert of claim 1, wherein the support member includes a loop member coupled to the main body.

9. The straight loop insert of claim 1, wherein the snap-fit member is disposed around the shaft of the fastener in the assembled configuration, between the head of the fastener and the seal.

10. The straight loop insert of claim 1, wherein the main body of the support member includes grooves in an outer surface thereof.

11. The straight loop insert of claim 1, wherein the plurality of projections are composed of a resilient and flexible material.

12. A straight loop insert configured to attach to a support surface defining a first side, a second side opposite the first side, and an aperture extending through the first and second sides, the straight loop insert comprising:
a support member including a bore;
a fastener removably coupled to the bore of the support member; and
a snap-fit member including a body supported by the fastener and a plurality of projections extending radially outwardly from the body,
wherein in response to an external force, each of the plurality of projections is movable from a first position, in which each of the plurality of projections is spaced apart from the main body by a first distance, to a second position, in which each of the plurality of projections is spaced apart from the main body by a second distance that is less than the first distance.

13. The straight loop insert of claim 12, wherein the plurality of projections is composed of a resilient and flexible material.

14. The straight loop insert of claim 12, further comprising a seal coupled to the support member, and wherein the seal is configured to press against the first side of the support surface to form a seal.

15. The straight loop insert of claim 12, wherein the plurality of projections are biased into the first position.

16. The straight loop insert of claim 12, wherein each of the plurality of projections includes a first end coupled to the body of the snap-fit member, and a second end opposite the first end, wherein the second end is movable relative to the body between the first position and the second position.

17. A method of attaching a straight loop insert to a support surface defining a first side, a second side, and an aperture extending through the first and second sides, the straight loop insert including a support member having a threaded bore, a seal, a snap-fit member having a plurality of projections, and a fastener having a head and a threaded shaft, the method comprising:
inserting the threaded shaft of the fastener through the snap-fit member, the seal, and the aperture in the support surface;
threading the fastener into the threaded bore of the support member; and
pressing the head of the fastener and the snap-fit member through the aperture from the first side of the support surface to the second side of the support surface, thereby causing the plurality of projections to deflect radially inward while passing through the aperture before being biased radially outward upon exiting the aperture.

18. The method of claim 17, wherein the seal presses against the first side of the support surface when the snap-fit member is positioned on the second side of the aperture.

19. The method of claim 17, wherein inserting the threaded shaft of the fastener includes positioning the snap-fit member between the head of the fastener and the seal.

20. The method of claim 17, further comprising pouring concrete onto the support surface after the plurality of projections have exited the aperture, thereby casting the support member in place.
